(19) United States
(12) Patent Application Publication
(10) Pub. No.: US 2019/0311289 A1
(43) Pub. Date: Oct. 10, 2019

(54) VEHICLE CLASSIFICATION BASED ON TELEMATICS DATA

(71) Applicant: Cambridge Mobile Telematics Inc., Cambridge, MA (US)

(72) Inventor: Linh Vuong Nguyen, Fremont, CA (US)

(21) Appl. No.: 16/375,170

(22) Filed: Apr. 4, 2019

Related U.S. Application Data
(60) Provisional application No. 62/654,742, filed on Apr. 9, 2018.

(51) Int. Cl. G06N 20/00; G07C 5/02; G06Q 40/08

(52) U.S. Cl. CPC G06N 20/00; G06Q 40/08; G07C 5/02

(57) ABSTRACT

Among other things, motion data is acquired from a device in a vehicle during a trip. The motion data is applied to a trained classifier to produce a commercial classification of the vehicle.

### CROSS-REFERENCE TO RELATED APPLICATIONS

This application claims priority to and the benefit of U.S. provisional application 62/654,742, filed on Apr. 9, 2018, which is incorporated here by reference in its entirety.

### BACKGROUND

In America, on average people spend more than 290 hours a year driving, logging more than 10,500 miles. Vehicle telematics offers a rich source for understanding users' driving behaviors. Recent advances from big data processing, machine learning and sensor networks have allowed for effective telematics data collection and processing, which have not only resolved many traditional problems, but also opened new avenues for studying new questions. Starting from 2006, MIT CarTel project has attempted to collect and analyze telematics data when driving simply by using smartphone devices (Bret Hull, Vladimir Bychkovsky, Yang Zhang, Kevin Chen, Michel Goraczko, Allen Miu, Eugene Shih, Hari Balakrishnan, and Samuel Madden. Cartel: a distributed mobile sensor computing system. In Proceedings of the 4th international conference on Embedded networked sensor systems, pages 125-138. ACM, 2006). Combined with big data processing and analytics, the project has also evaluated users' driving behavior and given suggestions to make them drive better.

With the development of big data techniques, automobile insurance companies are also changing their approach for insurance pricing. Traditional approaches are based on static, easily defined features, such as driver's age, gender, years of experience, as well as vehicle make and model. However, advances in big data have enabled the rise of a telemetry-based insurance model, for example the pay as you go model (J Ferreira and E Minike. Pay-as-you-drive auto insurance in Massachusetts: A risk assessment and report on consumer, industry and environmental benefits. Department of Urban Studies and Planning, Massachusetts Institute of Technology. Massachusetts Institute of Technology (http://dusp.mit.edu/) for the Conservation Law Foundation, http://www.clf.org/, http://www.clf.org/our-work/healthy-communities/modernizing-transportation/pay-as-you-drive-auto-insurance-payd, 2010). The new methods take into account extra information, such as vehicle mileage, usage pattern or risky driving behavior, and employ complex machine learning models for risk assessment. This allows for insurance companies to tailor an insurance plan for each user. The transition process has led to many interesting questions and forced revision on traditional insurance pricing methods.

### SUMMARY

In general, in an aspect, motion data is acquired from a device in a vehicle during a trip. The motion data is applied to a trained classifier to produce a commercial classification of the vehicle.

Implementations may include one or a combination of two or more of the following features. The motion data includes at least one of acceleration, location, and elevation. The commercial classification includes vehicle type. The commercial classification includes vehicle model. The commercial classification includes vehicle make. The device includes a sensor. The sensor includes an accelerometer. The sensor includes a GPS component. The sensor includes a gyroscope. The sensor includes a barometer. The sensor includes a magnetometer. The device includes a tag. The device includes a smart phone. The classifier is built based on vehicle type using motion data of trips, each trip being labeled with the commercial classification of the vehicle used on the trip. Heuristics are applied to an output of the trained classifier to correct classification of the trip. Features are extracted from the motion data for use by the trained classifier. The features include statistical features. The features include time-dependent features. The time-dependent features include autocorrelation coefficients a vertical acceleration. The features include event-based features. The features include suspension response. The features include power to weight ratio. The features include aerodynamics and longitudinal friction. The features include lateral dynamics. The features include hard acceleration or hard de-acceleration. The features include spectral features. The spectral features are associated with engine vibration. The spectral features are derived from gyroscope fluctuations. The features include metadata features. The metadata features include one or more of: time of day, trip duration, or type of road. The classifier produces a probability distribution over different commercial classifications of the vehicle. The heuristics include taking account of two consecutive matching trips. The heuristics include taking account of two trips for which the trajectories match. The features implicitly contain driver input. The classifier takes account of driver usage patterns.

These and other aspects, features, and implementations can be expressed as methods, apparatus, systems, components, program products, methods of doing business, means or steps for performing a function, and in other ways.

These and other aspects, features, and implementations will become apparent from the following descriptions, including the claims.

### DESCRIPTION

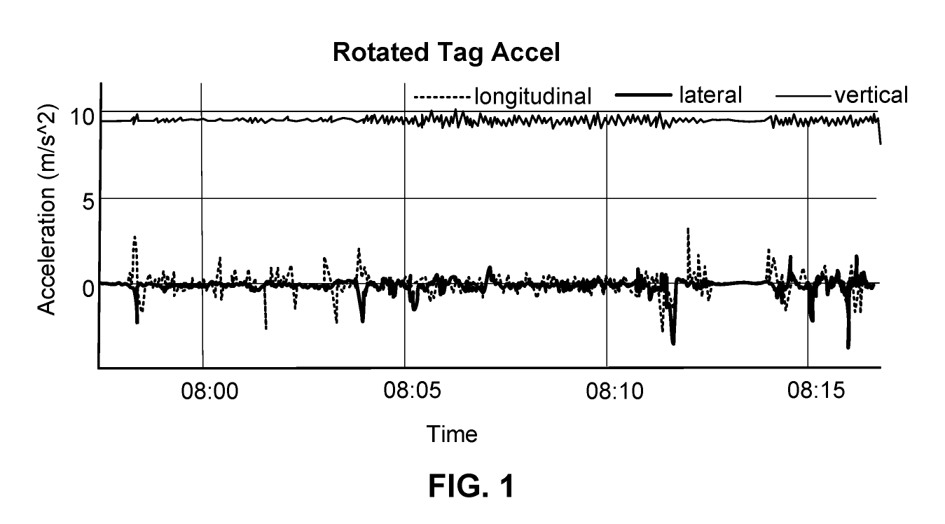

FIG. 1 is a graph of recorded data versus time.

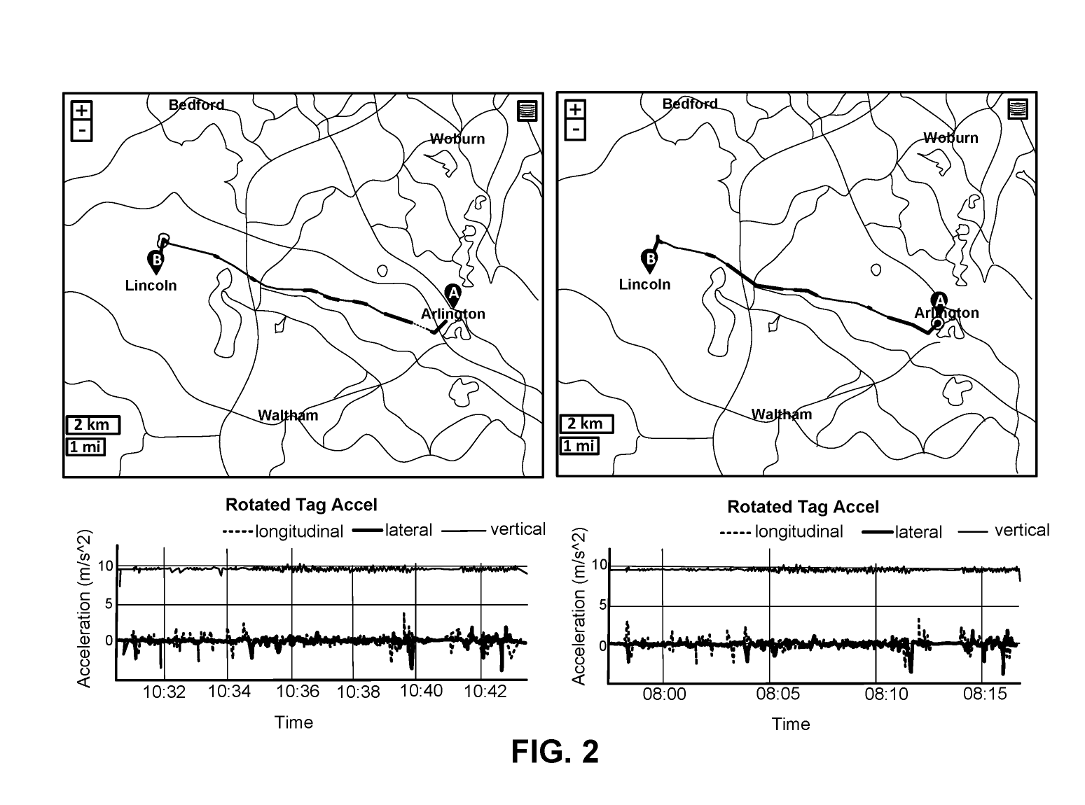

FIG. 2 is a comparison of recorded data versus time.

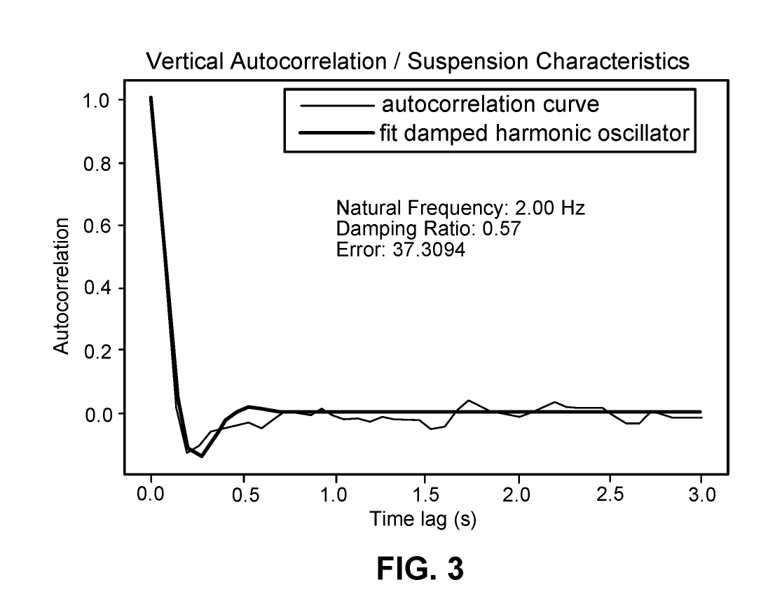

FIG. 3 is a graph of suspension response versus time.

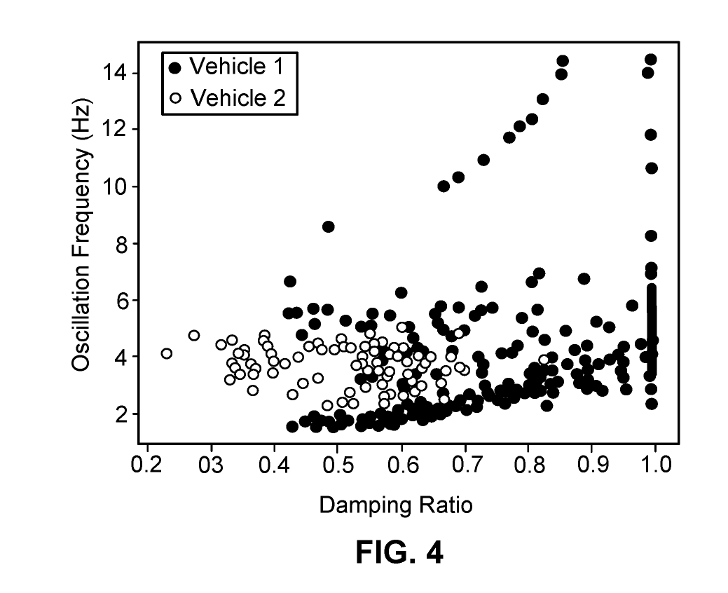

FIG. 4 is a graph of statistical features of vertical acceleration.

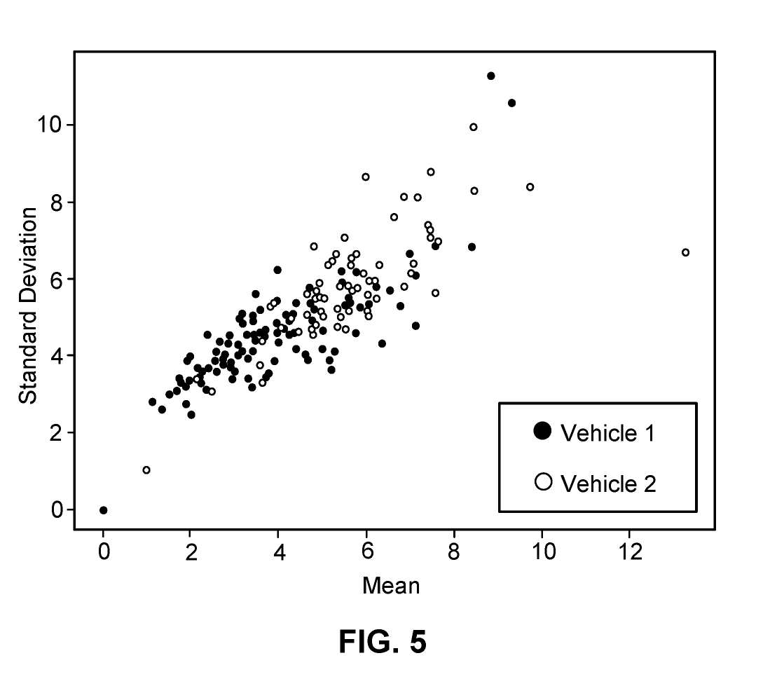

FIG. 5 is a graph of power to weight ratio.

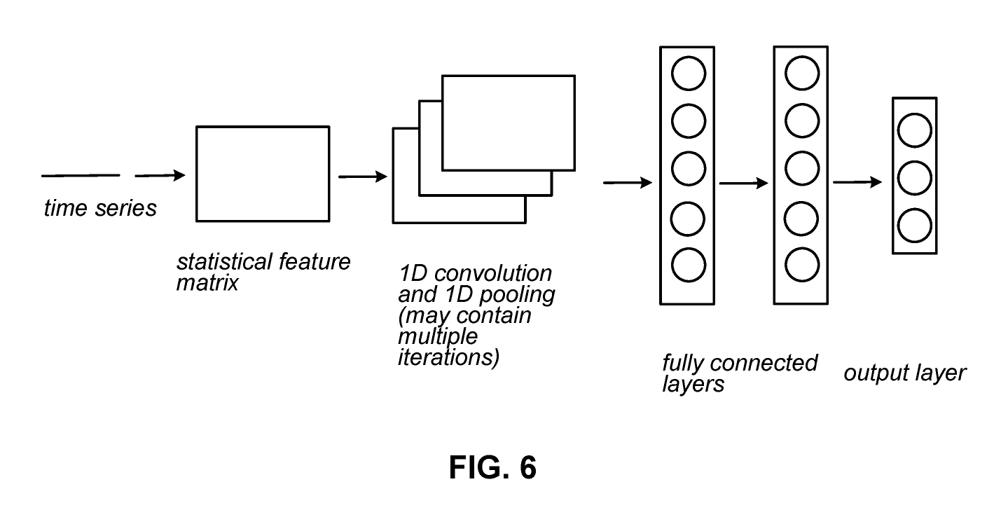

FIG. 6 is a block diagram of a convolution neural network.

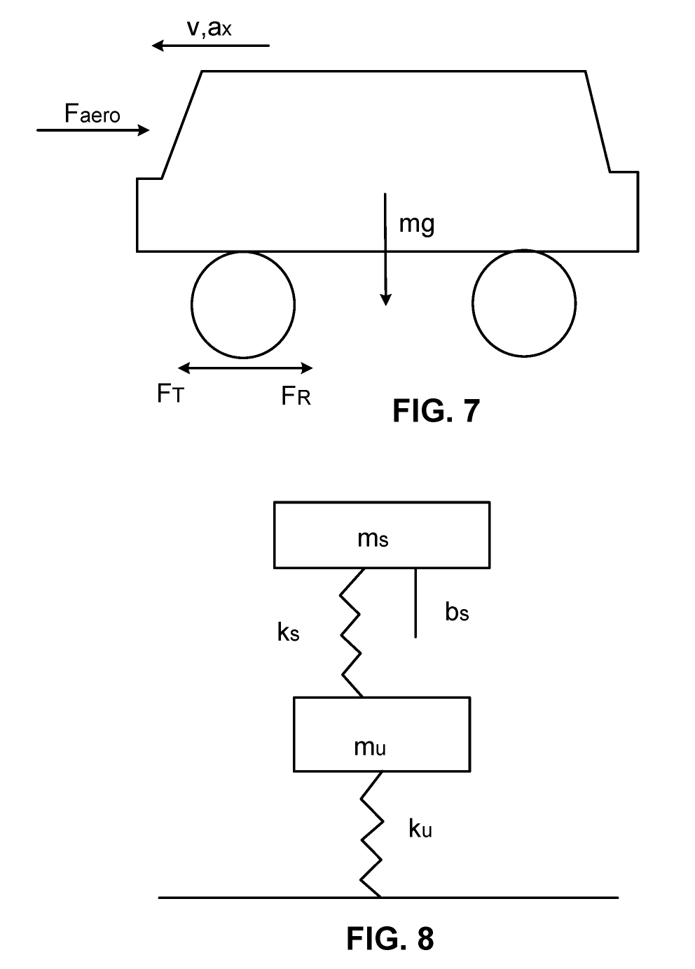

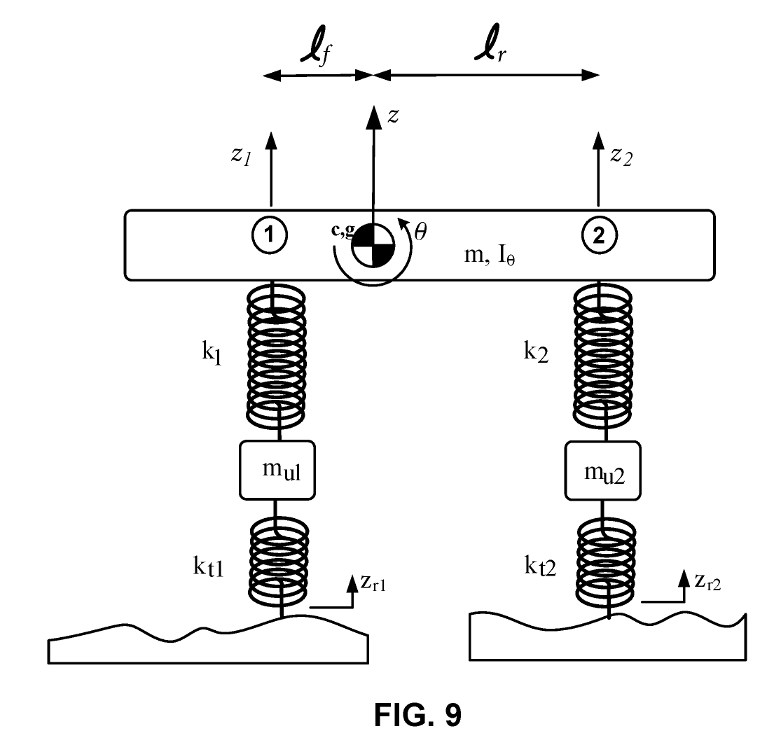

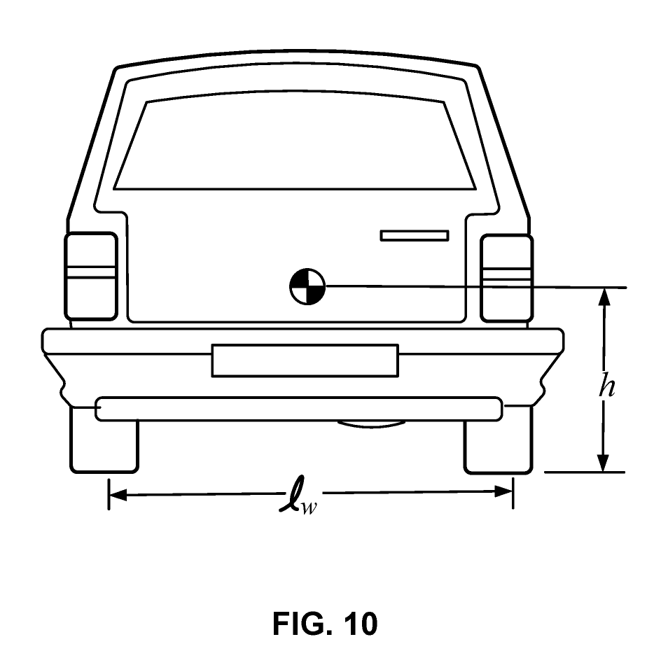

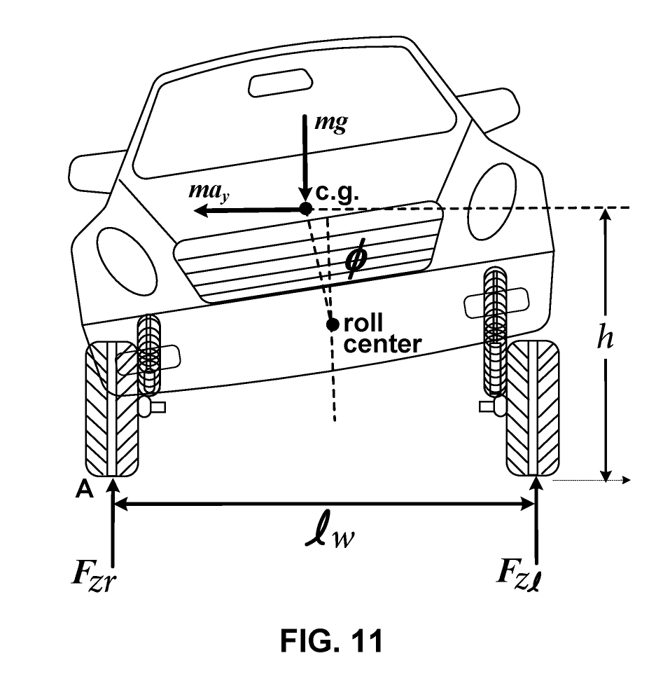

FIGS. 7 through 11 are schematic diagrams.

The technology that we describe here uses rich telematics data collected on trips for, among other things, vehicle model recognition. In some implementations of the technology vehicle model recognition is used for vehicle identification of a user. That is, given a driving history of a user on multiple trips, each trip represented by its telematics data, the technology identifies all available vehicles and clusters the trips based on which vehicle the person is using.

There are multiple applications of the results. For example, determining which vehicle was driven by a user enables analytic and behavioral study on their driving behavior and helps in making suggestions to improve their driving. From insurance companies' perspective, this enables them to study large scale behavior of users with respect to vehicle models, for example, to determine which vehicle models are more prone to unsafe driving behavior.

In some implementations, vehicle identification can be used to help determine a driving score for a driver of the vehicle. In general, unsafe driving behavior, such as hard acceleration, braking, or cornering, may vary across different vehicle models or vehicle types, such as SUVs, sedans, motorcycles, compact vehicles, and recreational vehicles, among others. For example, driving behavior that is unsafe in a certain model or type of vehicle may not be considered unsafe in another model or type of vehicle. By identifying the model or type of the vehicle used by the driver, the technology described here can inform the analysis of telematics data associated with the driver to recognize safe and unsafe driving behavior by the driver. For example, in some cases, the technology can apply model or type-specific thresholds or other metrics to the telematics data to distinguish between safe and unsafe driving behavior based on the vehicle used by the driver. In some cases, the technology can compare the telematics data with multiple instances of known driving behavior information to recognize safe and unsafe driving behavior, to identify the vehicle used by the driver, or to correlate driving behavior with vehicle model or type, or combinations of them, among others. The technology may use the vehicle identification and the recognized safe and unsafe driving behavior, among other data, to determine a driving score for the driver of the vehicle. The driving score may be presented to the driver, for example, to help the driver improve their driving behavior. In some cases, the driving score may be presented to an insurance company or another third party, for example, to allow the insurance company to tailor their insurance plan for the driver. A significant issue in working with telematics data is poor quality of the data, which has a wide variety of causes. Since telematics data is recorded in open road condition, such data can be affected by external factors, such as road bumps, traffic or pitch elevations. Such external factors could at best add noise into measurements, and at worst corrupt recorded data (for example, driving through a tunnel makes GPS data become unavailable). Another difficulty comes from the unpredictable nature of human input, which is often case-specific. Smartphone position, if data is recorded from the smartphone, can also add noise to the measurement. The low sampling rate also limits the ability to extract more granular features, which adds difficulty into designing good features that could differentiate different vehicle models.

Previous work has focused on various aspects of vehicle classification under different measurement conditions. The theory of vehicle modeling is documented in Giancarlo Genta. Motor vehicle dynamics: modeling and simulation, volume 43. World Scientific, 1997 and Rajesh Rajamani. Vehicle dynamics and control. Springer Science & Business Media, 2011. Traditionally, most measurements are done in a controlled environment, with the vehicle in factory condition and running on a closed circuit track, or require expensive preparation such as wind tunnel and various custom-made sensors. Such a controlled environment is generally not applicable in real life conditions, where external effects and driving characteristics can affect the measurements.

More recent work has attempted to develop algorithms under general conditions, using only measurements from smartphones. Researchers have employed a smartphone accelerometer to detect transportation mode (Samuli Hemminki, Petteri Nurmi, and Sasu Tarkoma. Accelerometer-based transportation mode detection on smartphones. In Proceedings of the 11th ACM Conference on Embedded Networked Sensor Systems, page 13. ACM, 2013) and have used vertical acceleration to estimate a vehicle's weight (Phong X Nguyen, Takayuki Akiyama, Hiroki Ohashi, Masaaki Yamamoto, and Akiko Sato. Vehicle's weight estimation using smartphone's acceleration data to control overloading. International Journal of Intelligent Transportation Systems Research, pages 1-12, 2015).

Telematics data belongs to the class of time series data, hence many techniques to extract features from time series data are relevant, such as statistical features, time-dependent features and spectral analysis. One source gives an overview on feature extraction techniques and their application in music fingerprinting (Geoffroy Peeters. A large set of audio features for sound description (similarity and classification) in the cuidado project. 2004).

A similar problem is classifying trips with respect to driving style, in which one author has proposed a deep learning solution (Weishan Dong, Jian Li, Renjie Yao, Changsheng Li, Ting Yuan, and Lanjun Wang. Characterizing driving styles with deep learning. arXiv preprint arXiv:1607.03611, 2016). The technology that we describe here, by contrast, must accommodate the fact that telematics data is dominantly influenced by driving input, which is heavily driver dependent, making it unclear how to extract invariant, vehicle-based features that do not depend on driving style.

The technology that we describe here includes an algorithm for recognizing vehicle type, and applying the vehicle type as part of user vehicle identification. The result included classification of 45 percent of trips according to the correct type of vehicle (SUV, compact or sedan). The technology also can determine features that could effectively discriminate different vehicle models (Honda Accord versus BMW 5 series).

The technology takes account of two important conditions that allow easy modification and scaling in the real world: granularity (the ability to identify vehicle type or vehicle model, not just transportation mode like train, car or walking) and ubiquity (requires only smartphone sensors and collects data on open road conditions versus controlled environment such as closed circuit and wind tunnel).

In some implementations, the telematics data is recorded either from a user's smartphone or from a customized hardware device designed by Cambridge Mobile Telematics of Cambridge, Mass. and attached to the vehicle, referred to here simply as the tag. In some applications data can be collected from both a smartphone and a tag. In one body of telematics data, trips were recorded in multiple locations from 2013 to 2017. Various sensors recorded data at different sampling rates, but for simplification we assume all sensors sampled at a fixed rate, achieved by subsampling for sensors with higher sampling rate and linear interpolation for sensors with lower sampling rate. Table 1 lists available measurements and corresponding sensors.

TABLE 1
List of available measurements and corresponding sensors

| Measurements | Sensor used |
|---|---|
| Longitudial (aₓ), lateral (a_{y}) and vertical acceleration (a_{z}) | Accelerometer |
| Position and velocity (v) | GPS |
| Roll, pitch and yaw | Gyroscope |
| Road pitch | Barometer |
| Vehicle orientation | Magnetometer |

As shown in FIG. 1, the tag records data in raw form for a given trip and the data accounts for all the external factors that can affect the measurement. For example, gravitational force causes a constant downward acceleration in the vertical direction of the accelerometer. Road bumps or poor weather conditions can also affect the quality of the tag's reading. A processing algorithm subsequently filters such external effects and aligns the measurements to correspond to the orientation of the road. For many trips, the example data included a label of vehicle make and model, which was accepted as correct. However, the label was provided by users, and for many users there is no information about their vehicles. There are 30 million such labeled trips, and 90 million unlabeled trips in the set of data analyzed. The data also included metadata useful for analysis including trip information (trip start/end timestamp, start and end locations, duration and distance) and anonymized user IDs.

The technology uses a semi-supervised learning algorithm. A classifier is built on vehicle type (such as SUV, compact or sedan) using data from many trips of many users. The classifier can then be applied to predict the vehicle type on trips by a particular user. Heuristics can be applied to vehicle usage pattern to group certain trips into the same vehicle type classes.

Although the technology can be characterized as addressing a clustering task, the technology does not implement a clustering algorithm, which can require a notion of similarity, and in some algorithms require knowing the number of clusters in advance. Results obtained from clustering algorithms can be hard to interpret, and there is no obvious strategy on how to improve the results beside feature engineering, which is often a trial and error process. When a large amount of labeled data is available, semi-supervised approaches can be used, if interpreted correctly.

Algorithms that rely on global features (for example, global analysis throughout the trip) suffer from the lack of discriminable features and noise incurred by various factors from the trip, such as traffic conditions.

As shown in the comparison between two different trips driven by different vehicle models in FIG. 2, in the long run, trip trajectory becomes the discriminative factor, dominating the local difference stemming from driving different vehicles. Therefore, the technology uses a classification algorithm that exploits local structures of the time series data where it suffices to discriminate different vehicle models. The technology accepts to some extent features that are affected by drivers, since driving behaviors are governed by vehicle characteristics. Road condition, weather or traffic, on the other hand, are excluded.

Techniques from machine learning suggest collecting locally based characteristics as the features, such as accelerating, engine characteristics, suspensions, steering and cornering.

Various work from physics and mechanical engineering give initial intuition for constructing such models, but there are two departure from traditional engineering models. On one hand, the technology aims to reconstruct the model based on empirical data instead of confirming the validity of the model under road test. On the other hand, measurement error, limited sampling rate and open road condition may cause deviation from the ideal model, and the technology uses a more abstract or simplified model for the sake of computational efficiency.

Although sampling rate limits the ability to obtain precise values of the parameters, in practice, the technology does not need such precision. Since the same feature from different trips in the dataset is computed using the same algorithm, as long as the feature extraction function is reasonably well defined and continuous, small adjustments to the function would result in a small change in the feature values, which retains their classification ability.

Since the classifier is inevitably noisy, there will be errors in classifying user's trips. Therefore, the technology applies heuristic correction, which looks at trip history as a sequence of points and find correlations between some pairs of trips. Those correlations allow the technology to put trips into the same vehicle type where the generic classifier cannot decide with certainty.

To summarize, the technology uses three steps:

1. Build a classifier on vehicle type, using trips having labeled data.

2. For each user, use the classifier to classify unlabeled trips.

3. Apply subsequent heuristic correction to group certain trips into the same cluster and output the final clusters.

Feature Extraction

Unlike typical high-dimensional data, time series data often comes at different dimensions and different channels, making typical feature extraction or dimensional reduction approaches such as Principal Component Analysis (PCA) or Singular Value Decomposition (SVD) difficult or not feasible. The technology uses three approaches:

1. Extracting statistical features after removing invalid data points in the data. The selected features include mean, standard deviation, skew, kurtosis; 25, 50, 75 percentile, and minimum/maximum value. This approach ignores the time-dependent nature of the data; however, its simplicity can essentially capture the nature of the time series, directly relate to the physical quantities capturing the vehicle's characteristics, and achieve good classification results in practice.

2. Extracting time-dependent features from the data. The most notable feature comes from evaluating the spectrogram of the signal. On the flip side, the features obtained from these techniques are not readily explainable, since they are only tangentially associated with the physical quantities. However, they can capture local and unusual behavior of the vehicle, making them strong indicators for classification.

3. Extracting event-based features, for example, hard braking and hard acceleration. These events are often time localized and caused by external sources from the driver road conditions. These features require more engineering and parameter tuning to achieve good discriminative accuracy.

Several features are inspired from modeling vehicle dynamics. Table 2 lists the dynamics and associated measurements, and later discussion explains intuitively how to extract features. Formal derivations of these models are deferred to the Appendix.

TABLE 2
List of available dynamics and corresponding measurements

| Vehicle Dynamic Model | Associated measurements |
|---|---|
| Longitudinal Dynamics | aₓ, v |
| Lateral Dynamics | a_{y}, v |
| Suspension Response | a_{z} |
| Rolling Dynamics | a_{y} and roll angle |

Suspension Response

The suspension system is designed to reduce the shock coming to the vehicle upon encountering road artifacts, such as potholes. The technology models the suspension as a damped harmonic oscillator that satisfies the following differential equation

$$\frac{{d}^{2} z}{d {t}^{2}} + 2 ζ {ω}_{0} \frac{d z}{d t} + {ω}_{0}^{2} z = 0 \qquad ( 1 )$$

where ω₀ is the undamped angular frequency of the oscillator, and ζ is the damping ratio. Here 0<ζ<1 since the damped spring gradually kills oscillations caused by road impacts. With impact value A₀ at time t=0, the damping value follows

z(t)=A₀e^{-ζt} sin(ω₀t) (2)

To learn the parameters ω₀ and ζ, the technology computes the autocorrelation of the vertical acceleration data. Let v(t) be the vertical acceleration at time t. For a lag s≥0, the autocorrelation corresponding to s is defined by

$$a ( s ) = \frac{\int v ( t ) v ( t + s ) d t}{\int {\vert v ( t ) \vert}^{2} d t } \qquad ( 3 )$$

with v(t)=0 for values of t outside the domain of interest. Note that the denominator corresponds to the autocorrelation at s=0, so that a(0)=1. The values a(s) correspond to the empirical damping values of the suspension response derived from actual data. The values ω₀ and are chosen to minimize error

$$( {ω}_{0} , ζ ) = arg {min}_{0 \leq ζ < 1 , ω \geq 0} {\int }_{t} {( {e}^{- ζ t} sin ( {ω}_{0} t ) - a ( t ) )}^{2} d t \qquad ( 4 )$$

As demonstrated by the suspension response over time shown in FIG. 3, since the technology uses empirical data, it is inevitable that there are variations of the returned values accounting for measurement errors. However, there are patterns across the trips. For comfortably riding cars, the damping ratio is typically low (at 0.2-0.3) to maximize user comfort, while for offroad and race cars the damping ratio is higher (typically 0.5-0.7) to quickly smooth the impact.

As demonstrated by the plot in FIG. 4, where the horizontal axis represents damping ratio and the vertical axis represents oscillation frequency, vertical acceleration is manifested from many car-specific features, such as weight and suspension response (Phong X Nguyen, Takayuki Akiyama, Hiroki Ohashi, Masaaki Yamamoto, and Akiko Sato. Vehicle's weight estimation using smartphone's acceleration data to control overloading. International Journal of Intelligent Transportation Systems Research, pages 1-12, 2015). Hence in addition to computing the damping coefficient and frequency, the technology can also compute statistical features of vertical acceleration. However, since vertical acceleration is affected by vehicle speed, the technology partitions the vertical acceleration values using vehicle speed and collects their features separately (Hiroki Ohashi, Takayuki Akiyama, Masaaki Yamamoto, and Akiko Sato. Modality classification method based on the model of vibration generation while vehicles are running. In Proceedings of the Sixth ACM SIGSPATIAL International Workshop on Computational Transportation Science, page 37. ACM, 2013).

Another issue is a vehicle's weight. In practice, the reading from vertical acceleration depends on a vehicle's load, which might include, beside curb weight, passenger's weight, fuel and extra loads. The extra loads are especially problematic for estimating parameters of SUV-type vehicle since the vehicle's weight varies significantly between different trips.

Power to Weight Ratio

By Newton's second law, the power can be represented as

P=Fv=maₓv (5)

However, using only accelerometer and GPS sensors, there is no obvious way to infer vehicle mass, so the technology relies on the power to weight ratio which is P/W=aₓv. Collecting such ratio for each valid sample yields a timeseries representation on acceleration capacity and engine responsiveness of the vehicle. Since power to weight ratio can capture the instantaneous change of the engine, we consider it a more reliable metric than the conventional metrics, such as braking distance or 0-60 mph time. The technology collects statistical features from the timeseries.

FIG. 5 shows a plot of the standard deviation and mean power to weight ratio for different vehicles. Note that the empirical power to weight ratio is different from the power to weight ratio quoted from manufacturers, which is often measured at peak engine performance at curb weight (no driver on board). Nevertheless, it is an important measure, since power to weight ratio depends exclusively on engine performance. Comfortably riding and compact cars often have lower power to weight ratio, while sport cars, luxury cars and SUVs have high power to weight ratio to compensate for larger vehicle size.

Aerodynamics and Longitudinal Friction

Vehicle longitudinal dynamics follow the equation

F=maₓ=F_{T}−Fₐₑᵣₒ−F_{R} (6)

where F_{T} is forward tire force, Fₐₑᵣₒ is aerodynamic drag and F_{R} is longitudinal rolling friction. At high speed, the dominant drag force is aerodynamic drag, which is proportional to the square of the vehicle's velocity

Fₐₑᵣₒ=½QC_{D}Av² (7)

where Q is atmospheric density, C_{D} is vehicle's drag coefficient and A is vehicle frontal area. Information about vehicle aerodynamic specification can be found on table 8 of the Appendix. Certain types of vehicle, such as SUVs, have higher drag area compared to other types. Therefore they need higher engine power to operate and are less responsive to brake and accelerator compared to other vehicle types. Statistical features of longitudinal acceleration and square of velocity would therefore capture the difference between vehicle types.

Lateral Dynamics; Steering Features

Measuring vehicle handling is tricky, because the input impulse coming from steering has small magnitude and occurs in a very short period of time. A natural approach would be to measure the turn radius, corresponding to how tight a vehicle can make a turn. There are two issues with this approach:

1. Noises coming from driving behavior. This is a minor issue since turn radius tends to correlate with how tight a turn a driver will make.

2. Noises coming from traffic. This is a major issue since traffic often blocks the vehicle from making a small turn as designed. Traffic law also causes drivers to make left turns larger than right turns (assuming the law mandates drivers to drive on the right side of the road).

A better approach is to rely on statistical features from a gyroscope sensor, in particular the yaw rate. Recall that the centrifugal acceleration is derived by the equation

$$a = \frac{{v}^{2}}{R} \qquad ( 8 )$$

where a is yaw rate, R is the radius of the turn and v is vehicle's speed. Therefore at any instant, v²/a characterizes the vehicle's turning capability. Excluding small values of a (indicating vehicle is not turning or ensuring numerical stability), we can collect the statistical features of turn radius.

Autocorrelation Coefficients

Previous features ignore the time dependent nature of the time series, which contains important information about vehicle characteristics. For example, autocorrelation describes the vehicle wheelbase, since when the vehicle is excited by road bumps, the time lag between two consecutive bumps correlates with vehicle's wheelbase length. The technology computes the autocorrelation coefficients of vertical acceleration following the equation

$${c}_{d} = \frac{{\sum }_{i = 1}^{n} v [ i ] v [ i + d ]}{{\sum }_{i = 1}^{n} {v [ i ]}^{2}} \qquad ( 9 )$$

(here we normalize c₀=1), and use the first five coefficients as features. Similar definitions can be made for other types of measurements.

Hard Acceleration and Hard Braking

These features are time localized and characterize many of the characteristics of vehicles, as they directly correlate with braking and transmission of a vehicle. The technology defines a hard acceleration as the longitudinal acceleration exceeding 0.5 m/s² and an acceleration frame as the consecutive period the hard acceleration exceeds such threshold. For each frame, the technology computes the duration and mean acceleration in that period and aggregates over different frames using statistical extraction.

The same idea applies for braking events, using −0.5 m/s² as a threshold. Similarly, the technology can extract features with lateral acceleration and vertical acceleration as input.

Spectral Analysis

The spectral content of a time series often contains rich information about time series' characteristics, making it a useful feature to compute. Spectral analysis has been widely applied in a number of domains, including image classification (Dengsheng Lu and Qihao Weng. A survey of image classification methods and techniques for improving classification performance. International journal of Remote sensing, 28(5):823-870, 2007) and speech recognition (Geoffroy Peeters. A large set of audio features for sound description (similarity and classification) in the cuidado project. 2004). In vehicles, spectral content comes from engine vibration, when the vehicle is either moving or at idle state. Vehicle model classification can be based on analysis of the sound emitted by the engine as the vehicle moves, detected by fluctuation of the gyroscope. However, the sampling rate of sensors may not be high enough to capture such information. Therefore the technology can use lower frequency characteristics, such as idle state vibration which has frequency of 1-2 Hz. As the vehicle can experience non-idle events, such as accelerating and braking, it is useful to take the Short Time Fourier Transform instead of a global Fourier Transform (Geoffroy Peeters. A large set of audio features for sound description (similarity and classification) in the cuidado project. 2004). The technology partitions the time domain signal into overlapping short frames and applies the Fourier Transform independently on each frame. Using overlapping frames mitigates the artificial boundaries that result from creating frames.

On each frame, the technology computes spectral energy, spectral centroid and spectral variance, and aggregates over different frames using statistical extraction. The technology also computes the spectral flux across the frames, which characterizes the change of spectral content over time. The details on how to compute these features are described in Appendix A.2.

Feature Engineering

Although the technology attempts to extract features from trips, the signals of some trips are corrupted, rendering them unsusceptible to feature extraction. In such cases, the algorithm discards the entire trip from consideration. Experiments shows that, with the given set of features, only 10 percent of the trips are discarded.

The discrimination accuracy can be improved on some special cases by including metadata features, for example time of day, trip duration or type of road. The intuition is that, for a single driver, there are consistent driving behaviors associated with each vehicle model. However, as one objective is to build a classifier on vehicle type, utilizing data from all drivers, the large variance among drivers makes such metadata features useless. Hence those features are not taken into account when building the classifier. The technology uses these metadata features only on a per user basis.

Algorithms

Granularity

A challenge in classification is to decide at which level of granularity the algorithm should work. Using vehicle make and model directly may be too granular, as there are more than 800 distinct vehicle models, and the usage frequency differs significantly between different models. In addition, with too few drivers driving a certain vehicle model, the classifier risks overfitting for these specific drivers. Likewise, selecting vehicle manufacturer as a label is also not a good option, since within the same manufacturer there are multiple types of vehicles, each having very distinct vehicle characteristics.

Instead, the technology restricts the granularity to vehicle type; that is, the technology classifies whether a trip is driven by a compact, sedan or SUV. We manually label some of the popular vehicle models with their corresponding vehicle type and build the corpus using only these vehicle models.

TABLE 3
List of popular vehicle models and their type

| Vehicle model | Vehicle type |
|---|---|
| VOLKSWAGEN POLO | sedan |
| FORD FIESTA | sedan |
| HYUNDAI I20 | sedan |
| FORD RANGER | SUV |
| VOLKSWAGEN GOLF | sedan |
| AUDI A4 | compact |
| BMW 320I | sedan |
| FORD ECOSPORT | SUV |
| TOYOTA COROLLA | compact |
| HONDA JAZZ | sedan |
| AUDI A3 | compact |
| KIA RIO | compact |
| FORD FIGO | sedan |
| LAND ROVER DISCOVERY | SUV |
| BMW 320D | compact |
| OPEL CORSA | sedan |
| FORD FOCUS | compact |
| HYUNDAI IX35 | sedan |
| TOYOTA FORTUNER | SUV |
| VOLKSWAGEN TIGUAN | SUV |
| MERCEDES-BENZ C180 | compact |
| RENAULT CLIO | sedan |
| TOYOTA YARIS | compact |
| NISSAN QASHQAI | SUV |
| KIA PICANTO | SUV |

The following discussion discusses only vehicle make and model, ignoring internal variants within vehicle model (such as year of manufacturing, engine power or number of doors in the vehicle.)

This list can be potentially expanded, both in term of vehicle make/model and their corresponding label classes with minimal change in the algorithm. Here we discuss a partition based on similar vehicle characteristics of the corresponding type. This classification is not perfect, however, as some of the listed vehicle models share characteristics of two different vehicle types.

Classification

Classification is a classic problem in machine learning with many available approaches. The technology uses a Random Forest classifier thanks to its ability to process heterogeneous data types (Leo Breiman. Random forests. Machine learning, 45(1):5-32, 2001). Using the classifier, for each trip the technology obtains a probability distribution over types of vehicles.

Since the classifier is trained on the generic case, it ignores certain user-based information, which could be introduced during the classification step. For example, having knowledge on the upper bound of number of vehicles a user has can help restrict the hypothesis space. Suppose we have a classifier, modeled as a function h:X×Y→[0,1] where X is the space of all trip features, and Y is the space of all possible labels. For each x∈X, the classifier has a probability distribution over Y, that is

$${\sum }_{y ∈ Y} h ( x , y ) = 1 ,$$

and denote p(x):=argmax_{y∈Y}h(x,y). For a driver having trips x₁, . . . , xₙ, assuming trips are taken independently, their joint probability is

$${\prod }_{i = 1}^{n} h ( {x}_{i} , p ( {x}_{i} ) ) \qquad ( 10 )$$

The key observation is that the set M={p(x₁), . . . , p(xₙ)} corresponds to the vehicles the driver uses, hence its cardinality could not be exceedingly large. A reasonable assumption is to restrict to |M|≤k for some small k and reverse the process by searching for all k-subset M of Y and compute the joint probability

$$P ( {x}_{1} , … , {x}_{n} , M ) = {\prod }_{i = 1}^{n} {max}_{{y}_{i} ∈ M} h ( {x}_{i} , {y}_{i} ) \qquad ( 11 )$$

Choose M₀ that maximizes P(x₁, . . . , xₙ, M₀) and normalize the likelihood of vehicle types of the trip of interest.

Heuristic Correction

Although the discussion has involved prediction using only telemetry information, this approach ignores metadata of the trip, such as time of day that the trip takes place, location, duration and distance. Since driver's behavior follows predictable patterns, the technology can use specific heuristics that, with high confidence, group certain trips into one group sharing the same vehicle. The key is to consider their driving history as a sequence of trips, and find correlations between consecutive trips.

The technology applies two notable heuristics here:

1. Consecutive matching: if two trips are close in time and the start location of the second trip is close to the end location of the first trip, it is likely the driver used the same vehicle for the later trip, hence two trips come from the same vehicle.

2. Trajectory matching: assuming that the driver is likely to repeat some trajectories over time, the technology can assign trips having similar trajectories (in either direction) to be driven by the same vehicle. This can be implemented simply and with good accuracy by checking several major locations, such as start and end location. To avoid having to search through many trips, the technology can consider only trips within a window of 3 days.

Although the equivalence relation introduced by the two heuristics is not necessarily transitive, we could nevertheless group all such linked trips to the same vehicle. To assign the cluster label for these trips, we calculate the joint probability

$$P ( {x}_{1} = c , … , {x}_{n} = c ) = {\prod }_{i = 1}^{n} h ( {x}_{i} , c ) \qquad ( 12 )$$

and choose label c maximizing the joint probability.

Other Approaches

For comparisons, the technology can implement alternative algorithms. These approaches also help reveal the nature of the dataset and characteristics of discriminative features.

1. Raw value: for each trip, create a feature vector consisting of the sensor's measurements without any feature engineering. Pick an interval of 2 minutes and use three accelerometer sensors, thus having a feature vector of 2×60×15×3=5400 elements. Train a Random Forest classifier based on these features.

2. Feature engineering-based algorithms, but with some components removed. The technology can implement two cases, one with only statistical features, and another combining statistical features and event-based features (but without spectrogram features).

3. 1-dimensional Convolutional Neural Network (1D-CNN). This approach has achieved success in classifying trips by driving style (Weishan Dong, Jian Li, Renjie Yao, Changsheng Li, Ting Yuan, and Lanjun Wang. Characterizing driving styles with deep learning. arXiv preprint arXiv:1607.03611, 2016). In deep learning-based algorithms, instead of doing extensive hand-crafted feature engineering, one can instead implement a neural network that implicitly learns such features during training, automatically choosing the right features depending on specific applications.

In some implementations, the technology can use a 2-minute segment of the trip, which is further divided into frames of 2 seconds long with 1 second overlapping between consecutive frames. In each frame, the technology computes statistical features of the measurements and arranges the features to form a statistical feature matrix. As demonstrated by the 1D convolutional neural network diagram shown in FIG. 6, the technology applies convolution and max pooling across frames only in the time domain. The results after convolution and pooling are connected to fully connected layers and subsequently the output layer.

Influence of Driver on Vehicle Identification

As explained above the technology implicitly extracts features containing driver input, despite performing engineering techniques to reduce their influence. Since driver input is a significant part of a telematics signal, the natural question arises: how big is its influence on vehicle identification? There are two cases, trips containing only a single driver, and trips coming from multiple drivers.

If the technology is restricted to the same driver case, a supervised method would still give good classification results. The reason is that driving style is consistent for a driver, and by conditioning on the driver the remaining signal manifests the difference between vehicle models.

On the other hand, if the dataset contains trips from multiple users, classification becomes significantly harder. Different drivers own different variants of the same vehicle model, and even on the same vehicle model their usage has a large variation. In addition to building the classifier, choosing the right granularity is also crucial for applying to user vehicle identification.

Results

As discussed above, a classification or clustering algorithm needs to be robust in various conditions. Driving style may be a major factor affecting the classification accuracy. Therefore, we design a suite of tests covering the following scenarios:

1. Same driver test, with the same driver driving multiple vehicle models. The classifier is expected to classify trips based on vehicle models.

2. Driving style test, where trip history comes from multiple drivers, labeled by the driver. The classifier is expected to classify trips by their corresponding drivers.

3. Vehicle model test, where trip history comes from several predetermined vehicle models, each driven by many drivers. The classifier is expected to classify trips by their corresponding vehicle models.

4. Vehicle type test, where trip history comes from many vehicle models, each is labeled by its vehicle type. The classifier is expected to classify trips by their corresponding vehicle type.

The testing can also be done using the described classifier combined with additional heuristics for user vehicle identification.

For experiments, we typically restrict the size of the data set due to computational constraints. On each test, we collect data conforming to the testing scheme described, split into training and testing data and report accuracy at 10-fold cross validation (CV). The accuracy here indicates the percentage of trips classified with their correct label. We find that the accuracy plateaus with sufficient data. All the analysis are done using Amazon AWS c4.x8large instance.

Classification

Same Driver Test

We run multiple tests. For each test we select a driver driving regularly at least two vehicle models (and for which each vehicle model represents at least 10 percent of the total number of trips). We select two most popular models per user and balance their vehicle representativeness in data. The classifier is trained using Random Forest with all the features described earlier. The following accuracy is reported per pair of vehicles driven by the same user.

TABLE 4
Classification results of same driver test

| Vehicle Model 1 | Vehicle Model 2 | Accuracy (10-fold CV) |
|---|---|---|
| HONDA CIVIC | MITSUBISHI | 79.8 |
| | PAJERO | |
| TOYOYA CAMRY | HONDA JAZZ | 84.2 |
| BMW 435I | BMW 550I | 87.0 |
| VOLKSWAGEN | MERCEDES- | 79.3 |
| AMAROK | BENZ C200 | |
| HYUNDAI SANTE | FIAT BRAVO | 84.8 |
| FORD FIGO | KIA RIO | 67.2 |
| KIA SEDONA | PEUGEOT 107 | 87.8 |
| BMW 320D | TOYOTA RUNX | 87.2 |

As shown here, conditioned on the same driver, the classifier is able to differentiate vehicle models at high accuracy. Although all tests are designed with only two vehicle models, it is trivial to extend to multiple vehicle models, accepting a marginal drop of accuracy. Hence the problem can be solved efficiently if for each driver there is sufficient labeled data about trip history per vehicle model (about 20 trips per vehicle). The technology can build a classifier per user and apply that on user vehicle identification.

What remains a hard question is to identify vehicle models on users without any labeled data.

Driving Style Test

We collect trip history of several drivers, labeling trip by the driver regardless of the vehicle model they are using. We select 100 trips per driver, running a Random Forest classifier and report the accuracy measured by 10-fold CV.

TABLE 5
Classification results of driving style test

| Number of drivers | Accuracy (10-fold CV) |
|---|---|
| 2 | 95.3 |
| 5 | 77.1 |
| 10 | 57.5 |

As shown here, the method reports good accuracy on classifying driving style.

Vehicle Model Test

We run the experiment with multiple pairs of vehicles. In each test, we collect 2000 trips per vehicle model, subject to no more than 30 trips coming from the same driver. We train the classifier using Random Forest classifier.

TABLE 6
Classification results of vehicle model test (many drivers)

| Vehicle Model 1 | Vehicle Model 2 | Accuracy (10-fold CV) |
|---|---|---|
| BMW 320D | NISSDAN TIIDA | 77.5 |
| FORD FIESTA | MAZDA CX-3 | 52.1 |
| KIA RIO | ISUZU KB250 | 71.2 |
| HYUNDAI SANTE | KIA SOUL | 67.3 |
| AUDI A3 | BMW Z4 | 75.6 |
| HONDA JAZZ | MERCEDES- | 70.4 |
| | BENZ SLK | |
| HYUNDAI I20 | LAND ROVER | 77.0 |
| | RANGE | |
| AUDI A4 | HONDA CIVIC | 59.8 |

The accuracy drop compared to the same driver test suggests that the proposed feature engineering approach does take driver characteristic into account, which accounts for more variance among drives in the same class. The result also shows that the classification accuracy is higher on pairs of vehicles of different types, suggesting that a classifier by vehicle type, albeit noisy, could still serve as a good indicator for user vehicle identification problem.

Vehicle Type Test

In this experiment, we sample 20000 trips from each type of vehicle, using only vehicle models listed on Table 3 and conditioned so that no driver has more than 30 trips in the dataset. We then build a classifier on vehicle type. Here, there are three different vehicle types: SUV, compact and sedan. The result is listed as the percentage of trips having vehicle type classified correctly.

TABLE 7
Classification results of vehicle type test

| Algorithm | Accuracy (10-fold CV) |
|---|---|
| Raw value | 33.5 |
| 1D-CNN | 35.0 |
| Basic + events | 40.5 |
| Basic + events + spectrogram | 45.0 |

In table 7, we use the following shorthand notation:

Basic: indicate all features collected via statistical extraction methods and time-dependent features, mainly vehicle dynamics features, but excluding spectral features.

Events: indicate event-based features, such as hard acceleration and braking.

Spectrogram: indicate features obtained from computing spectrogram.

As shown here, directly using raw values does not give any better predictive ability than random guessing. While CNN and basic features help obtaining some discriminate accuracy, the significant contribution comes from using a vehicle's short time response, manifested through spectral features.

Clustering

We applied the classifier to the clustering problem. To evaluate the results, we need to distinguish between users having one vehicle and users having two or more vehicles, since the evaluation metric differs.

For users having only one vehicle, the metric is the ratio between the size of the largest cluster and total number of trips. In this case, without heuristics, the average ratio is 0.75 and with heuristics the average ratio is 0.9, implying the classifier approach does recognize there is only one cluster.

For users having two or more vehicles, we need to compare obtained clusters with ground truth data, subject to permutations of labels. By constructing the confusion matrix and sum over permutation having the largest size, divided by total number of trips, we find that without heuristics the average ratio is 0.55 and with heuristics the average ratio is 0.60. In this case, the classifier recognizes different vehicles to some extent.

The result shows that the classifier tends to assign trips by the same vehicle to different clusters, hence the heuristic can correct to some extent. A more robust classifier would likely improve the identification accuracy. Accordingly, there is a limiting factor on accuracy obtained with multiple vehicles, and a supervised approach may yield a better result.

The technology that we have described requires only data collected from smartphone sensors with simple set up, enabling its scalability and ubiquity in various environments. The success of the algorithm combines both study of vehicle dynamics and understanding of driver's usage pattern, the latter is to compensate for difficulties of implementing a “pure” machine learning algorithm. A simple extension of the algorithm allows for classification of transportation mode, such as train, bike or walking.

Variations in results are sometimes related to different phone positions (for example, hand or pocket) and different smartphone models (for example, Android versus iPhone). While the basic measurements are the same, different smartphone models also apply different algorithms for motion detection or filtering noise. Distinguishing the difference of data quality collected by different smartphone models may be useful in improving classification results.

In practice, a user-input trip may alternate between different modes of transportation (such as car to bus or train). Even when using only a single vehicle in a trip, not all collected data comes exclusively from driving; for example, a user can stop the vehicle at a gas station, refuel and resume driving. Trip segmentation, which separates different modes of transportation interleaved in a given trip, would improve the analysis accuracy and give more insights on users' driving behavior.

The technology that we have described on time series analysis often extracts the features from a single time series one at a time. A vectorized approach, which extracts features of multiple time series could provide further insights and relations between different measurements of the vehicle. Likewise, the features obtained during the extraction step only loosely depends on vehicle dynamics. A more systematic approach could be to construct a vehicle dynamical model, and infer underlying parameters.

In addition to classifying vehicle types, similar technology can be applied to estimate vehicle's parameters, such as curb weight, dimensions and aerodynamics coefficients. This would depend on the consistency of ground truth data from different and availability of the parameters for many vehicle models.

Although certain aspects of user behavior are considered to aid classification, these properties are often case-specific and heuristic. Having a systematic approach in studying user behavior would be useful in implementing more robust vehicle identification models and help unveil the way drivers use their vehicles.

Hardware and Software

In the discussion above, we have sometimes referred to the structures and functions of computer devices, mobile devices, and other devices. A wide variety of implementations of such devices are possible. In some implementations, a computer device can be implemented as various forms of digital computers, digital devices, or digital machines, including, e.g., laptops, tablets, notebooks, desktops, workstations, personal digital assistants, servers, blade servers, mainframes, among others. Mobile devices can be implemented as personal digital assistants, tablets, cellular telephones, smartphones, and other similar devices.

A computing device can include a processor, a memory, a storage device, a high-speed interface connecting to a memory and high-speed expansion ports, and a low speed interface connecting to a low speed bus and a storage device. These components can be interconnected using various buses, and can be mounted on a common motherboard or in other ways. The processor can process instructions for execution within the computing device, including instructions stored in the memory or on the storage device, to display graphical data for a GUI on an external input/output device, including, e.g., a display coupled to a high speed interface. In some implementations, multiple processors and/or multiple buses can be used with multiple memories and types of memory. Also, multiple computing devices can be interconnected, with each device providing portions of the necessary operations (e.g., as a server bank, a group of blade servers, or a multi-processor system).

The memory stores data within the computing device. In some implementations, the memory includes a volatile memory unit or units. In some implementations, the memory includes a non-volatile memory unit or units. The memory also can be another form of computer-readable medium, including, e.g., a magnetic or optical disk.

The storage device is capable of providing mass storage for a computing device. In some implementations, the storage device can be or contain a computer-readable medium, including, e.g., a hard disk device, an optical disk device, a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., the memory, the storage device, or the memory on the processor.

Each device can communicate wirelessly through a communication interface, which can include digital signal processing circuitry where necessary. The communication interface can provide for communication under various modes or protocols, including, e.g., GSM voice calls, SMS, EMS, or MMS messaging, CDMA, TDMA, PDC, WCDMA, CDMA2000, or GPRS, among others. Such communication can occur, for example, through the radio-frequency transceiver. In addition, short-range communication can occur, including, e.g., using a Bluetooth®, Wi-Fi, or other such transceiver (not shown). In addition, the GPS (Global Positioning System) receiver module can provide additional navigation- and location-related wireless data to the device, which can be used as appropriate by applications running on the device.

The computing device can be implemented in a number of different forms. For example, it can be implemented as a cellular telephone. It also can be implemented as part of a smartphone, personal digital assistant, pad, or other similar mobile device.

To provide for interaction with a user, the systems and techniques described here can be implemented on a computer having a display device for presenting data (including augmented reality information) to the user, and a keyboard and a pointing device (e.g., a mouse or a trackball) by which the user can provide input to the computer. Other kinds of devices can be used to provide for interaction with a user as well. For example, feedback provided to the user can be a form of sensory feedback (e.g., visual feedback, auditory feedback, or tactile feedback). Input from the user can be received in a form, including acoustic, speech, or tactile input.

Other implementations are also within the scope of the claims below.

1. A method comprising
acquiring motion data from a device in a vehicle during a trip,
applying the motion data to a trained classifier to produce a commercial classification of the vehicle.

2. The method of claim 1 in which the motion data comprises at least one of acceleration, location, and elevation.

3. The method of claim 1 in which the commercial classification comprises vehicle type.

4. The method of claim 1 in which the commercial classification comprises vehicle model.

5. The method of claim 1 in which the commercial classification comprises vehicle make.

6. The method of claim 1 in which the device comprises a sensor.

7. The method of claim 6 in which the sensor comprises one of an accelerometer, a GPS component, a gyroscope, a barometer, and a magnetometer.

8. The method of claim 1 in which the device comprises a tag.

9. The method of claim 1 in which the device comprises a smart phone.

10. The method of claim 1 comprising building the classifier based on vehicle type using motion data of trips, each trip being labeled with the commercial classification of the vehicle used on the trip.

11. The method of claim 1 comprising applying heuristics to an output of the trained classifier to correct classification of the trip.

12. The method of claim 1 comprising extracting features from the motion data for use by the trained classifier.

13. The method of claim 12 in which the features comprise statistical features.

14. The method of claim 12 in which the features comprise time-dependent features.

15. The method of claim 14 in which the time-dependent features comprise autocorrelation coefficients of a vertical acceleration.

16. The method of claim 12 in which the features comprise event-based features.

17. The method of claim 12 in which the features comprise one or a combination of two or more of suspension response, power to weight ratio, and aerodynamics and longitudinal friction.

18. The method of claim 12 in which the features comprise lateral dynamics.

19. The method of claim 12 in which the features comprise hard acceleration or hard deacceleration.

20. The method of claim 12 in which the features comprise spectral features.

21. The method of claim 20 in which the spectral features are associated with engine vibration.

22. The method of claim 20 in which the spectral features are derived from gyroscope fluctuations.

23. The method of claim 12 in which the features comprise metadata features.

24. The method of claim 23 in which the metadata features comprise one or more of: time of day, trip duration, or type of road.

25. The method of claim 1 in which the classifier produces a probability distribution over different commercial classifications of the vehicle.

26. The method of claim 11 in which the heuristics comprise taking account of two consecutive matching trips.

27. The method of claim 11 in which the heuristics comprise taking account of two trips for which the trajectories match.

28. The method of claim 12 in which the features implicitly contain driver input.

29. The method of claim 1 in which the classifier takes account of driver usage patterns.

30. The method of claim 1 comprising determining a driving score for a driver of the vehicle based on the motion data and the commercial classification of the vehicle.
